(19) United States
(12) Patent Application Publication
(10) Pub. No.: US 2019/0049906 A1
(43) Pub. Date: Feb. 14, 2019

(54) SYSTEM FOR, AND METHOD OF, CHANGING OBJECTS IN AN ENVIRONMENT BASED UPON DETECTED ASPECTS OF THAT ENVIRONMENT

(71) Applicant: ANDREW BENNETT, Belmont, MA (US)

(72) Inventor: ANDREW BENNETT, Belmont, MA (US)

(21) Appl. No.: 15/675,756

(22) Filed: Aug. 13, 2017

(51) Int. Cl. G05B 15/02; A41D 1/00

(52) U.S. Cl. CPC G05B 15/02; A41D 1/002

(57) ABSTRACT

This document describes a system in which a sensory instrumentality—detecting and monitoring its location within a particular environment—detects and monitors aspects of its environment (such as, for example, sounds, movements, lighting, colors, surfaces, smells, tastes, signals or combinations of the foregoing) and then sends signals that triggers changes in the environment (or objects in the environment) based upon certain relational matches of locations and aspects of the environment detected. The method described in this document includes the steps of detecting and monitoring locations and the surroundings of a sensory instrumentality, comparing the combination of location and surroundings readings with specific parameters, and causing a change in one or more aspects of or in the environment (or one or more objects in the environment) when there is a match between a particular location, the detected aspect of the surroundings, and the specific parameter.

### COPYRIGHT NOTICE

A portion of the disclosure of this patent application contains material that is subject to copyright protection. Noting the confidential protection afforded non-provisional patent applications prior to publication, the copyright owner hereby authorizes the U.S. Patent and Trademark Office to reproduce this document and portions thereof prior to publication as necessary for its records. The copyright owner otherwise reserves all copyright rights whatsoever.

### FIELD OF INVENTION

The invention relates generally to a system through which certain locations in and aspects of an environment are detected and monitored and changes are made in such environment or to objects in it when there is a match between a location, a detected aspect, and specific evaluation parameters.

### BACKGROUND

There are a great number of environments in which interactive automation between people in the environment and (A) objects in the environment, (B) aspects of the environment, or (C) a combination of the foregoing, enhance the experience of those in the environment. Examples of such environments include, without limitation, theaters, sports facilities, work training areas, amusement parks, educational venues, and more. In some of these environments, there are times in which those in the environment would like to synchronize their specific locations in the environment with changes in the environment or in objects in the environment. Traditionally, the coordination of the position of the person in the environment (e.g., the actor's place on the stage) and the change in the environment (e.g., the dimming of the light shown on the actor at that particular place on the stage) calls for another person to (1) watch, (2) listen and (3) act—dim the light.

The need to engage at least one other person—other than the principal person (the ‘principal actor’)—to match the principal person's location in the environment (for example, on the stage, on the playing field, or in the training facility) and other aspects of the situation (for example, the place in the script, the play being made on the field, the step of the process being learned) creates the possibility of shortfalls in performances or operations. For example, the lack of automation can result in latency, human error, reduced efficiency, less repeatability, and other possible shortfalls. Conversely, depending on the operation and the environment, an automated or at least semi-automated system and method can mitigate such shortfalls and possibly add flexibility and variability to the operation, depending upon the number and combinations of matches of (x) locations, (y) environmental aspects (situations and surroundings), and (z) triggering parameters that can be established in the system or through the practice of the underlying method. Although sounds in an environment are natural and often used aspects for triggering changes in an environment (e.g., the lighting director changes to the spot light when the lead actor begins her closing monolog center stage), it is desirable to have a system and method that can use more than sound as the evaluated aspect for triggering changes.

The prior art includes systems that detect and monitor certain aspects of environments. For example, the systems and methods disclosed in U.S. Pat. No. 5,973,998 (Showen et al), U.S. Pat. No. 7,567,676 B2 (Griesinger), U.S. Pat. No. 7,362,654 B2 (Britton), and WO1995024028A1 (Mcconnell), all have some form of sound detection capability, but none, for example and among other shortfalls, teaches or suggests (A) the detecting of any aspects of their environments other than sound, (B) detecting locations that are readily variable (as the sensor is in motion) with such varying of the locations being essential in determining changes in the environment to be triggered by the system, or (C) the evaluation of one parameter (which can be pre-established) in relationship to the detected aspect of the environment and the location of the sensor in the triggering of changes in and about the environment. In many of the prior art instances, the process ends with the reporting and not with an environmental change. Separately, the disclosure in US20150370323A1 (Cieplinski) presents a device that can identify a face and then perform a task based upon such identification, but the disclosed technology does not teach or suggest the detection of anything beyond or other than aspects of a person's face and the task performed are primarily limited to the device with which the person is facing.

The foregoing describes some of the shortfalls of the prior systems and methods. The present inventions (both the system and the method) are designed and have been developed to address these considerations and other challenges of the past.

### SUMMARY

The present invention comprises a system for interactively controlling aspects of an environment through the functionality of a sensory instrumentality in the environment. The sensory instrumentality has the capability of detecting its position in the environment and other external aspects of the environment (such as, for example, sounds in the environment, the movement of the sensory instrumentality in its surroundings, lighting in the area, colors within its sensory range, surfaces with which it comes in contact, smells in proximity, tastes of objects placed against it, or combinations of the foregoing). In one embodiment of the present invention, the sensory instrumentality is an element of a wearable garment. The garment can be, for example, a costume and the environment can be, by way of further example, a performance area (like a theater stage). Alternatively, the sensory instrumentality can be, or be contained in, an object carried by a user. The wearer/user can also be an animal.

In the operation of the present invention, the sensory instrumentality would be capable, during the period of its operation, of both (A) detecting, identifying and monitoring its position in its environment, and receiving the relevant aspect(s) (e.g., sounds, lighting, movement, colors, smells, tastes, electronic signals. etc.) of the same environment. Such sensory instrumentality is also able to either (x) interpret parameters correlating its position with relevant detected aspects and/or (y) electronically transmit the pertinent information (e.g., position and sensory readings) to a means of analyzing such information relative to such parameters. Based upon the correlation of parameters with the associated information, the present invention can transmit an outgoing signal that can change (A) one or more of the aspects of the environment (e.g., it can cause a change in the lighting based upon the position of a costume wearer and sounds detected), (B) one or more aspects of a garment to which it is attached or object in which it is contained, (C) aspects of a combination of the foregoing, or (D) some other element associated with the environment.

The parameters to be correlated can be pre-established and embedded within the sensory instrumentality. In another or more comprehensive embodiment of the inventive system, the parameters can be transmitted to the sensory instrumentality from a remote source. Further, the parameters can be established by causing the sensory instrumentality to register them on a case-by-case basis by activating a function in which the sensory instrumentality captures and stores, within the sensory instrumentality, the parameters in real or near real time.

The present invention also consists of a method of changing aspects of or objects in an environment based upon detected aspects of that environment. One step of the inventive process involves the establishment of the parameters that need to be met for there to be a change to be made in (A) one or more of the aspects of an environment (e.g., a change in the lighting in the environment or in an item in the environment), (B) one or more aspects of a garment of a person or animal in the environment, (C) aspects of a combination of the foregoing, or (D) some other element associated with the environment. A sensory instrumentality, with the capability of detecting its position in the environment and other external aspects of the environment, monitors the environment and reads, for example, sounds in the environment, the movement of the sensory instrumentality in its surroundings, lighting in the area, colors within its sensory range, surfaces with which the sensory instrumentality comes in contact, smells in proximity, tastes of objects placed against the sensory instrumentality, a signal from an external source, or combinations of the foregoing. In one embodiment of the present invention, the sensory instrumentality performs such monitoring when configured as an element of a wearable garment. In another embodiment, the sensory instrumentality performs such monitoring as, or as contained in, an object.

In the performance of the inventive method, the sensory instrumentality detects, identifies and monitors its position in the environment. It also receives the relevant aspect(s) (e.g., sounds, lighting, movement, colors, smells, tastes, incoming signals, etc.) of the environment it is in. Such sensory instrumentality either (x) interprets parameters and correlates its position with relevant detected aspects and/or (y) electronically transmits the pertinent information (e.g., position and sensory readings) to a device that can analyze such information relative to such parameters. Based upon the correlation of the then-established parameters with the associated information, the present invention includes the step of transmitting an outgoing signal that can change (A) one or more of the aspects of the environment (e.g., it can cause a change in the lighting based upon (i) the position of a costume wearer, (ii) sounds detected, (iii) movements of the custom wearer or objects in such wearer's possession, or (iv) a combination of the foregoing and/or other detectible circumstances), (B) one or more aspects of a garment to which it is attached or object in which it is contained, (C) aspects of a combination of the foregoing, or (D) some other element associated with the environment.

The inventive method can also, in a further embodiment, include the step of pre-establishing and embedding desired parameters within the sensory instrumentality parameters. Conversely or additionally, the parameters can be transmitted to the sensory instrumentality over time by one or more externally generated signals. Also, and possibly in the alternative, the parameters can be established by causing the sensory instrumentality to register such parameters on a case-by-case basis with the activation of a function in the sensory instrumentality that would capture and store, within the sensory instrumentality, the parameters in real or near real time.

### BRIEF DESCRIPTION OF THE FIGURES

FIGS. 1a-1d show the use of the present inventive system in a theatrical environment.

FIG. 2 shows the use of the present inventive system also in a theatrical environment but with additional elements that work in collaboration to cause changes in the environment.

FIG. 3 shows the use of the present inventive system in quarterback training.

FIG. 4 shows the use of the present inventive system in a more elaborate theatrical environment.

FIG. 5 shows the use of the present inventive system in firefighter training.

FIG. 6 shows the use of the present inventive system in a theatrical environment in which the audience wears sensors.

FIG. 7 shows a flowchart that reflects steps of an embodiment of the present inventive method.

### DETAILED DESCRIPTION

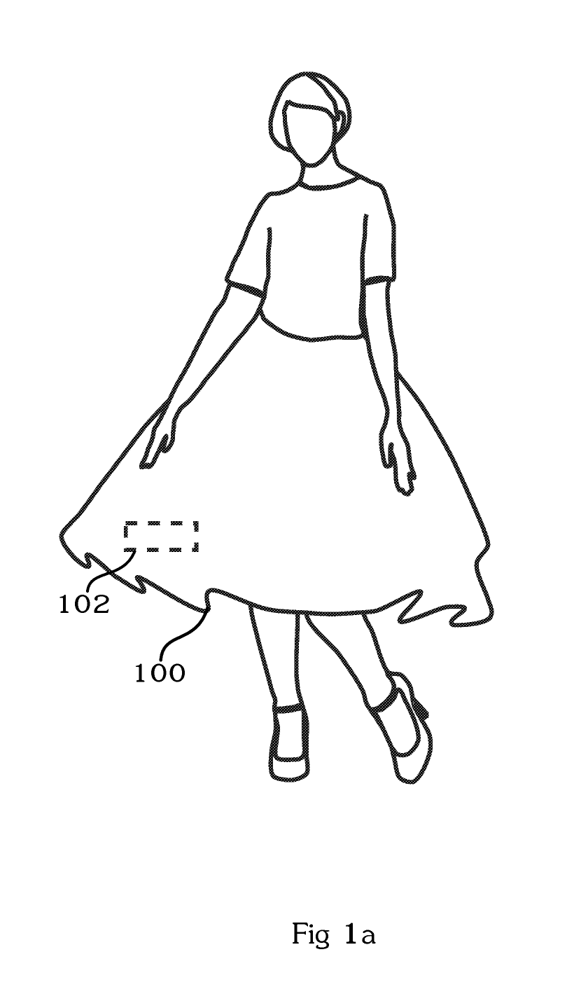

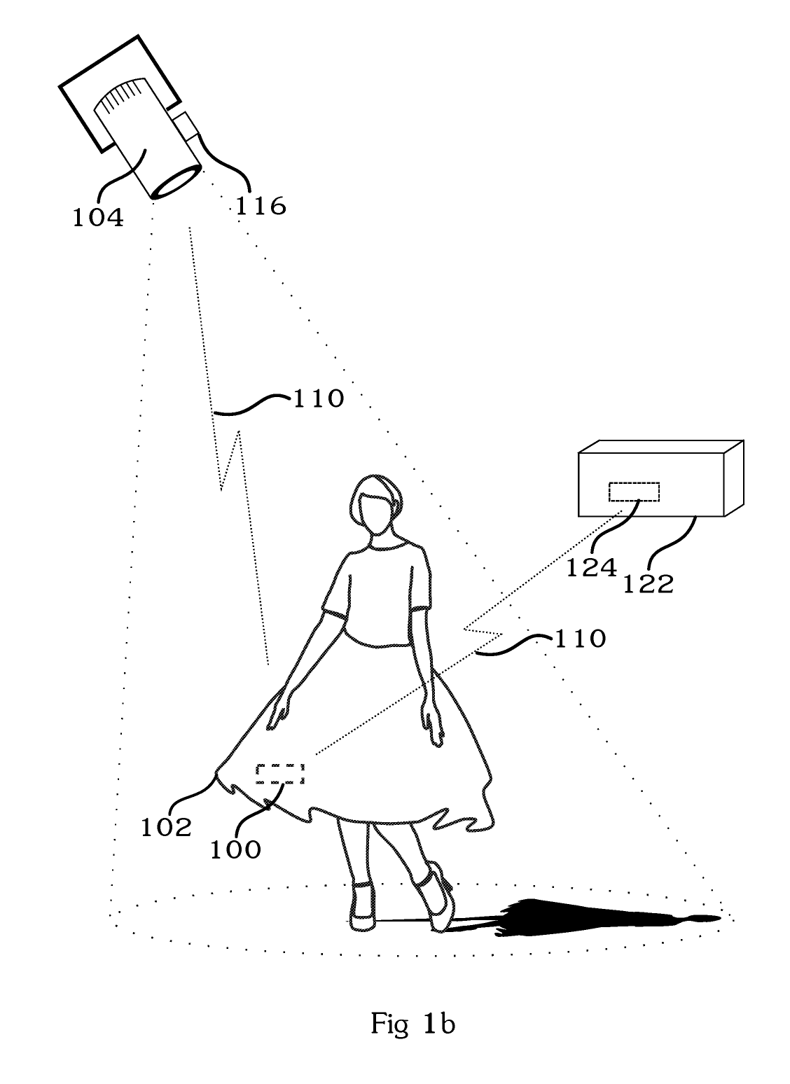

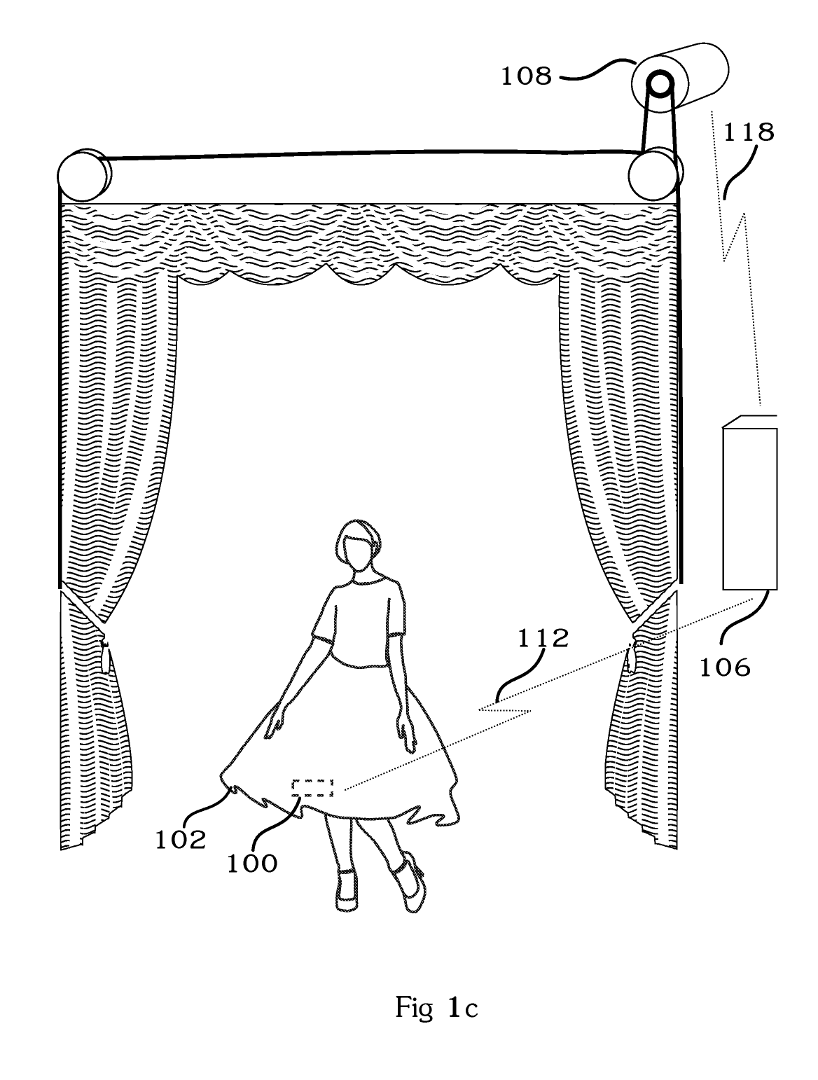

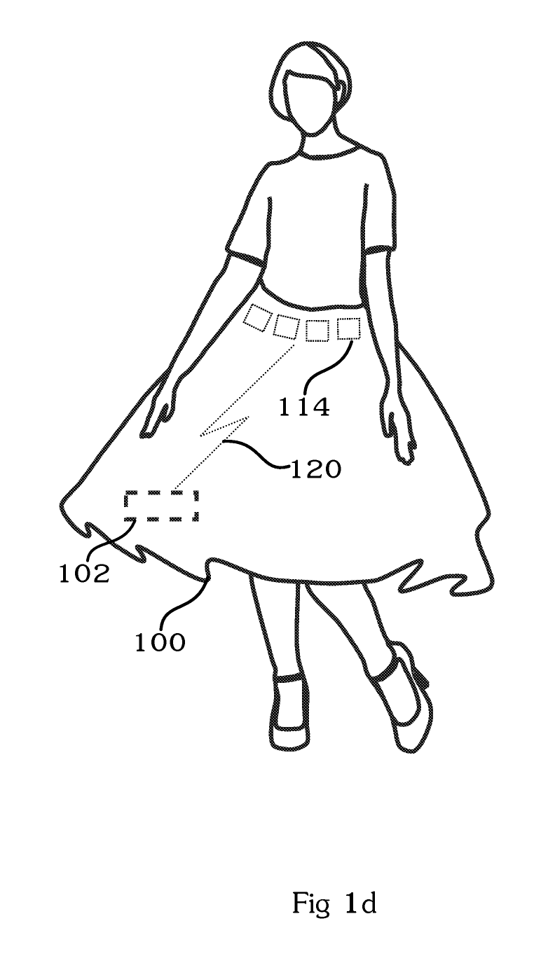

In a preferred embodiment of the present inventive system, a sensory instrumentality is used to detect, identify and monitor certain aspects of the environment in which it is situated. As shown in FIG. 1a-1d, sensory instrumentality 100 is attached to the inner bottom of costume 102 (see FIG. 1a specifically). In one embodiment of the present invention, sensory instrumentality 100 is an element of such a wearable garment. The garment can be, for example, a costume and the environment can be, by way of further example, a performance area (like a theater stage). Alternatively, sensory instrumentality 100 can be, or be contained in, an object carried by a user. The wearer/user can also be an animal. One of ordinary skill in the art would realize that the location and attachment of sensory instrumentality 100 on or about a user may vary depending upon the environment, the aspects to be detected and monitored, and the desired changes to be made through the practice and use of the present inventive system.

In this particular embodiment, sensory instrumentality 100 is set to ‘listen for’ audio cues. For example, sensory instrumentality 100 can be set to ‘listen for’ a string of spoken words. As suggested, the ‘listened for’ words can be pre-stored within sensory instrumentality 100 or, in another embodiment of the present invention, they can be transmitted to sensory instrumentality 100, possibly any time prior or in real or near real time. Additionally or alternatively, sensory instrumentality 100 can, for example, detect its movement within the environment, lighting in the area in which it is positioned, colors within its sensory range, surfaces with which it comes in contact (e.g., if it comes in contact with skin or a certain fabric), smells in proximity (e.g., a fog machines output or cookies baking in an on-stage oven), tastes of objects placed against it (bitter vs. sweet), signals generated by external sources, or combinations of the foregoing. Like with audio cues, the aspects to be detected and monitored can be pre-stored in sensory instrumentality 100 or transmitted into it after activation. Accordingly, in the operation of the present inventive system, sensory instrumentality 100 can receive the relevant aspect(s) (e.g., sounds, lighting, movement, colors, smells, tastes, signals, etc.) of the environment it is in.

Additionally, in the operation of the present inventive system, sensory instrumentality 100 would detect, identify and monitor its position in the environment it is in. One of ordinary skill in the art would realize that are numerous technologies that can be used for sensory instrumentality 100 to detect, identify and monitor its position within the environment. It is the coordination of the position of sensory instrumentality 100 and the detection of the anticipated sensory trigger(s) that, in essence and actuality, interactively control and cause changes in the desired aspects of the environment.

Depending upon the additional features and functions incorporated in sensory instrumentality 100, when in the desired position and, for example, when a certain string of spoken words is ‘heard’, sensory instrumentality 100 can transmit signal 110 to receiver 116—as shown in FIG. 1b. Elements like receiver 116 can be part of a computer that controls elements of the environment or part of apparatus in the environment. In this theater example, signal 110 can be transmitted to the controlling electronics of, for instance, the stage's lighting, a scene backdrop, a trapdoor, or an offstage signal. In FIG. 1b, receiver 116 is Bluetooth enabled and part of lighting fixture 104. One of ordinary skill in the art would realize that a multitude of technologies can be used to transmit and receive signal 110. Also, signal 110 can be received by receiver 122, which includes sensory instrumentality 124. Accordingly, changes in various aspects of the environment can be made in parallel or series based upon the signals received by sensory instrumentality 124 (even if there are other sensory instruments in the environment). Alternatively or additionally, as shown in FIG. 1c, signal 112, which can also be transmitted and received via a number of technologies, can be sent to panel 106, which is electronically connected via signal 118 with various apparatuses such as, for example, curtain motion motor 108.

Based upon the correlation of parameters with the associated information, as shown in FIG. 1d, the present inventive system can transmit signal 120 to change, for example, lighting 114 attached to costume 102, alternatively or additionally with changes made to some other element within the environment.

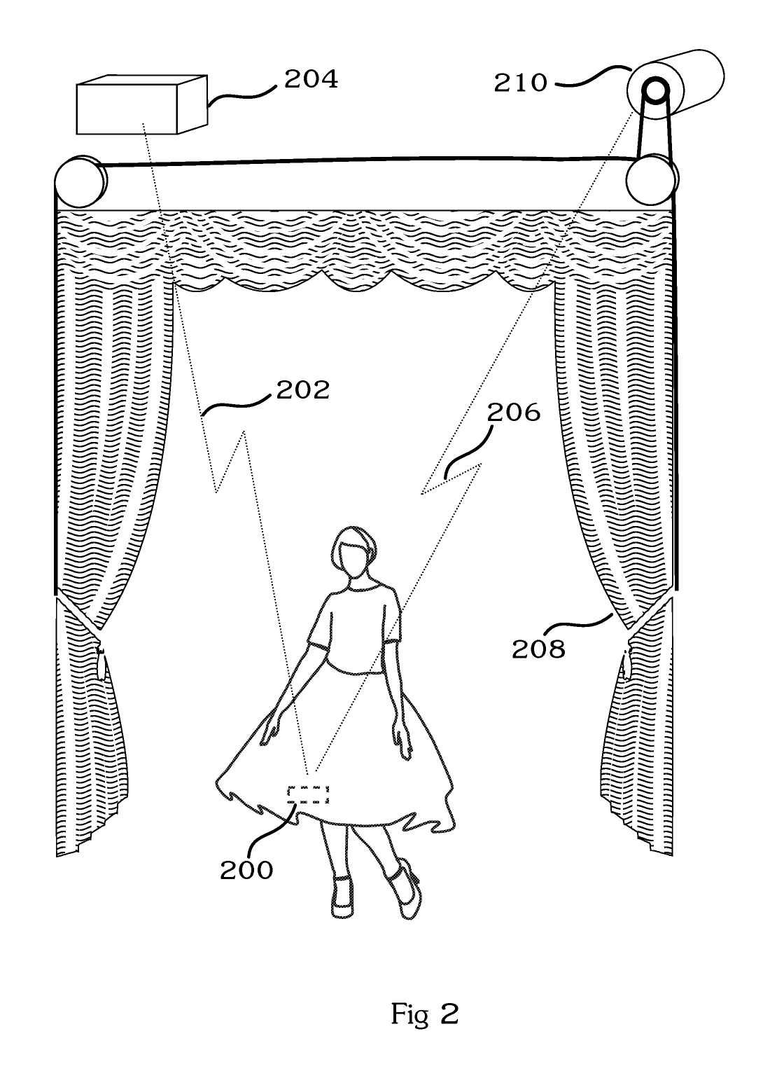

In a further embodiment of the inventive system, as shown in FIG. 2, sensory instrumentality 200 can receive signals 202 from CPU 204. Signals 202 can include parameters that are changed periodically (as programmed in CPU 204). The change in such parameters alters the triggers to be matched by sensory instrumentality 200 to cause signal 206 to cause the opening and closing of curtains 208 by signal receiving motor 210. There are a multitude of ‘events’ that can be triggered through the use of the inventive system or the performance of the inventive method. Examples of such possible events, occurring when, for example, the sensory instrumentality detects that the established parameters have been met, include changes made in the color, geometry, shape or a combination of elements of the outfit, costume, prop or other item that is associated with a theatrical production, changes in the lighting or the visible surroundings of the performer, audience, or prop on a stage, and an auditory response, such as, for example, music or sound effects. In another embodiment, the inventive system can help, for example, a performer by providing feedback about his or her performance in real time. For example, if a performer needs to move away from where he or she is standing at a particular time in the production, the inventive system could indicate the need for the movement via visual, audio or haptic feedback. Conversely, the inventive system could indicate when the performer is in the correct location and provide appropriate feedback (e.g. when a performer is on the correct mark for a camera angle, or even when a performer is in the correct location or pose to match footage previously captured, thereby helping to maintain continuity between filming sessions). The foregoing capability could also be extended to the correct positioning of props, curtains, lights, and more, with the inventive system indicating when such materials are correctly located for the next act of the performance or for continuation of a prior day of filming.

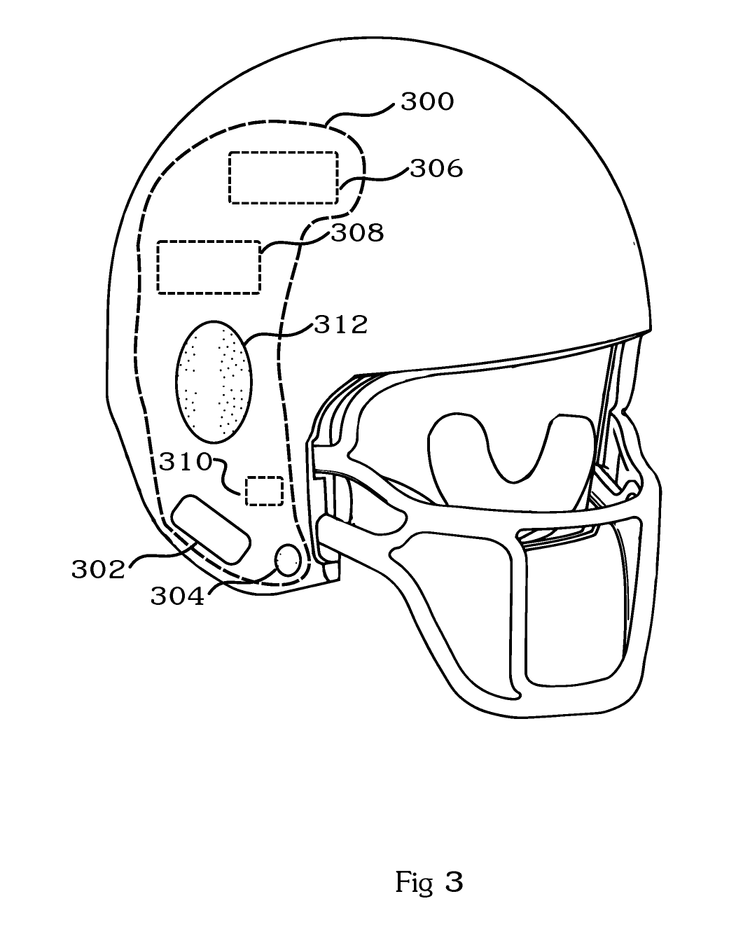

FIG. 3 shows an embodiment of sensory instrumentality 300. Configured to look like a piece of attachable equipment, sensor instrumentality 300 includes record/play button 302, microphone 304, GPS detector 306, receiver/transmitter 308, recording chip 310, and speaker 312. One use of such sensory instrumentality 300 would be in a quarterback training simulation. The coach can work with the quarterback, for example, to program sensory instrumentality 300 to ‘listen’ for audio cues from the quarterback (e.g., changing the play). The audio cues can be stored in recording chip 310 by depressing record/play button 302. Based upon the audio cue ‘heard’ by sensory instrumentality 300, if the quarterback moves to the desired position on the playing field (simulating a ‘rollout’), one of a choice of beacons on the playing field can light up when the quarterback was in the desired position to indicate where the quarterback should throw the ball. Additionally, the quarterback can be listening to a countdown to the time to throw generated by speaker 312. One of ordinary skill in the art would realize the foregoing ‘football’ example is one of a multitude of environments in which sensory instrumentality 300, with its components and functionality, can be used. In another scenario, such as in connection with the sport of shooting, the inventive system could ensure that the shooter's gun is kept in safe mode until the shooter assumes a correct posture and the gun is pointed in the desired direction. Similarly, the gun could show differentiating lights when the shooter is in either the correct or the incorrect shooting pose.

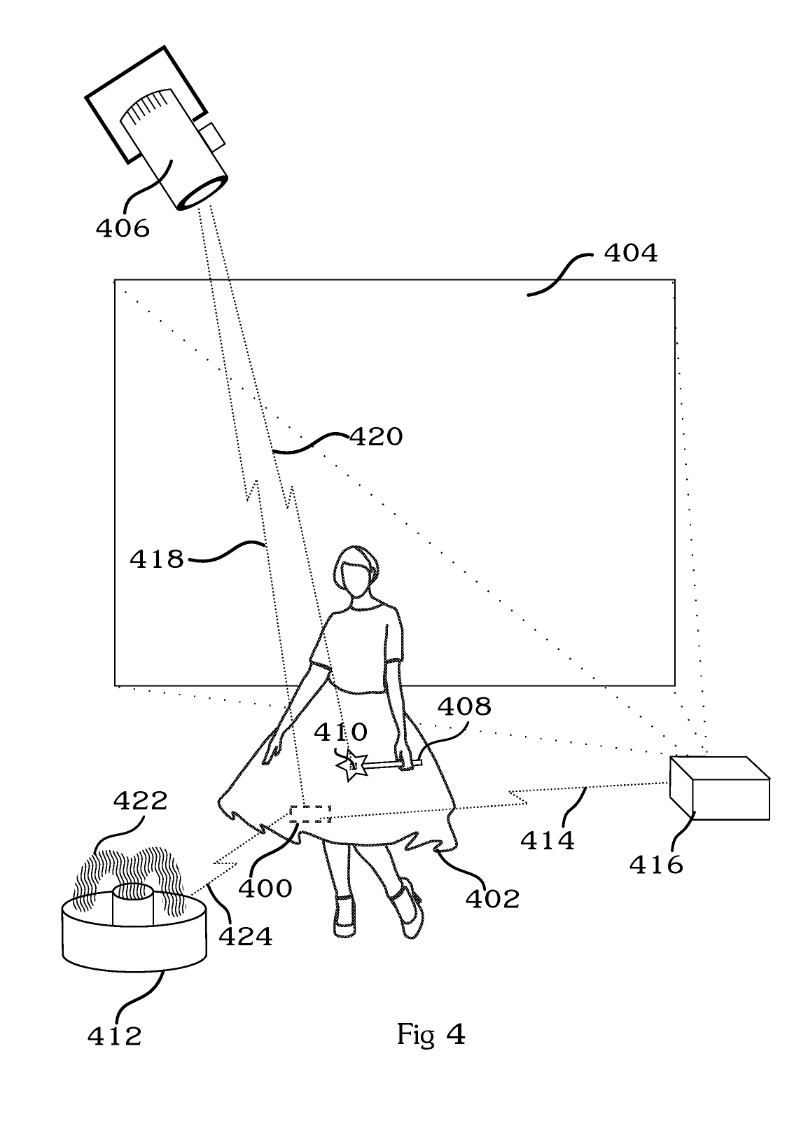

In one particular embodiment of the present invention, as discussed above and shown in FIG. 4, sensory instrumentality 400 can be part of costume 402 or embedded in an item of clothing that interacts with the environment. In a more particular embodiment, the present invention can be used in entertainment environments. In this kind of environment, the effects produced are controlled by the person wearing costume 402 and can be dependent upon on one or numerous factors. For example, the changes in the environment can be triggered through, for example, audio sensing (including for instance, voice recognition), location identification, object interaction, proximity readings, and combinations of the foregoing. In more detail, audio sensing capability in the form of voice recognition can be set so that, for example, a change is triggered when an actor wearing costume 402 with sensory instrumentality 400 configured to receive and analyze sounds has his or her words recognized as triggering parameters. Location identification capability within sensor instrumentality 400 can trigger, through signal 414 receivable by projector 416, a change in scene backdrop on screen 404 when sensory instrumentality 400 worn by the actor detects that the actor is positioned ‘stage right’. The combination of audio sensing and location identification capabilities in sensory instrumentality 400 (e.g., when worn by the actor) can be used alternatively or additionally to trigger, through signal 418 receivable by light fixture 406, a change in lighting when specific lines spoken from a script are ‘heard’ by sensory instrumentality 400 and the actor is center stage. With object integration, sensory instrumentality 408 is part of or embedded in object 410, shown as held in the hand of the actor in FIG. 4. It is the handling or other interaction of, for example, the actor with sensory instrumentality 408 containing object 410 in his or her hand, that can change the lighting produced by light fixture 406, through signal 420 receivable by light fixture 406, as the actor moves object 410 through the air. With regards to proximity, water 422 can commence flowing from onstage fountain 412 as an actor approaches it, speaking a triggering line in the script and as signal 424 is transmitted from sensory instrumentality 400 to onstage fountain 412. Having a costume 402 and/or object 410 that is conditional also permits for unique interactions with the audience. Another example of the use of the inventive system in the foregoing environment could involve the automatic tracking of boom microphones that would receive signals in real time regarding the location of the applicable actor(s) during a filming session. If properly configured and moved, the microphones could be positioned out of the viewing area of the cameras and the position could be changed without the microphones colliding with other set equipment or people. Under still another set of circumstances, a follow-spotlight could be focused upon one actor until he or she finishes his or her lines and then, for example, automatically move to the next speaker, having recognized where the actors are in the script and having received the location coordinates for each of the speaking actors.

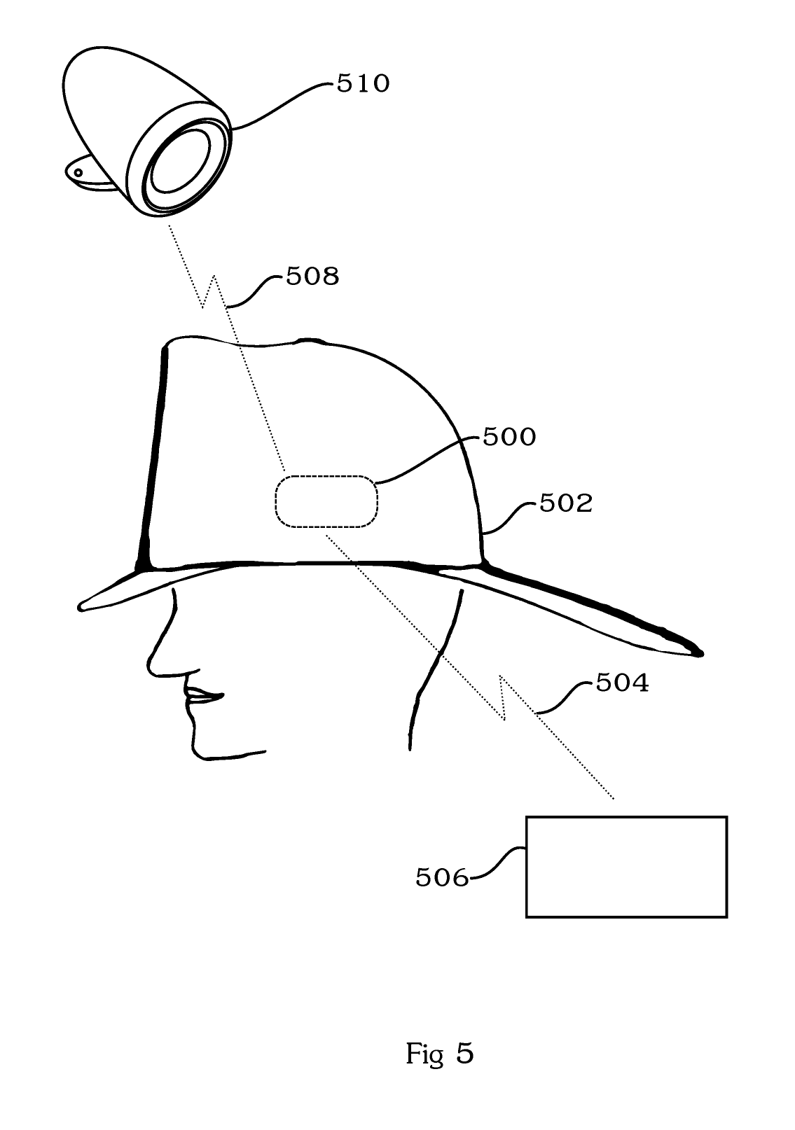

FIG. 5 shows an embodiment of the present invention that can be used in firefighter training. In this particular embodiment, sensory instrumentality 500 can be part of firefighter helmet 502. Within the training environment, sensory instrumentality 500 can detect, identify and monitor the trainee's location in the environment, through signals 504 that are transmitted between sensory instrumentality 500 and CPU 506 (that contains a diagram of the environment) and track the trainee's movement within the environment. Sensory instrumentality 500 can also detect and measure the level of smoke at each location within the environment. With the location and smoke level readings, sensory instrumentality 500 can, for example, automatically notify the firefighter through an earpiece that that he or she should start using or turn up oxygen (given the level of smoke at that particular location) or transmit signal 508 to light fixture 510 at that location to, for instance, simulate a sudden loss of power.

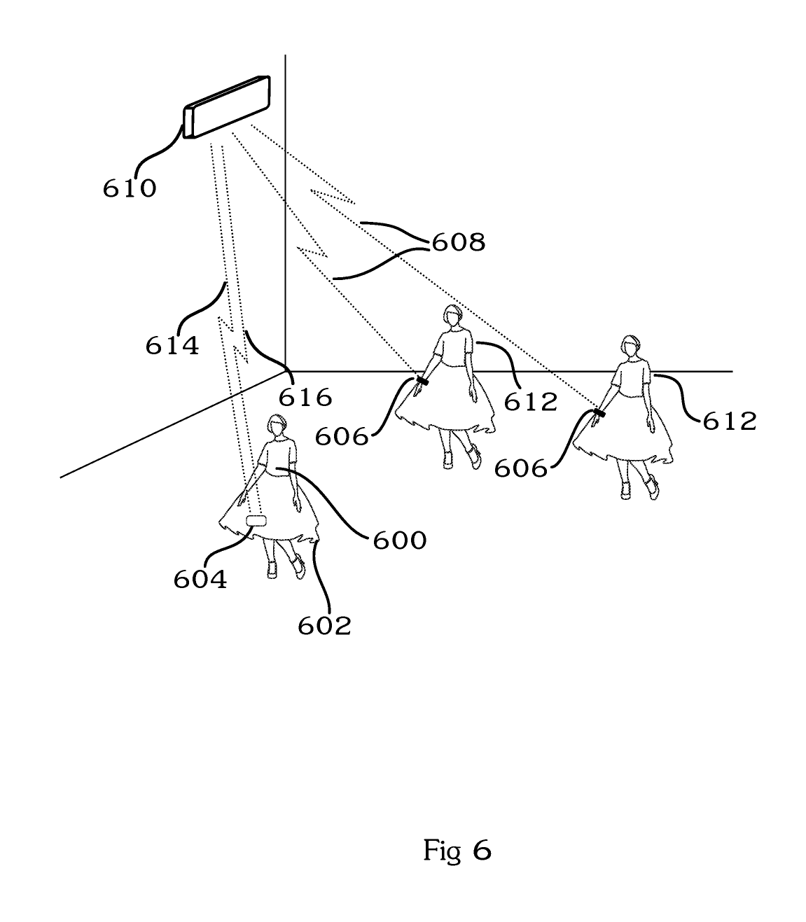

Another use in an entertainment environment is shown in FIG. 6. In this particular embodiment, host 600 is wearing costume 602, which has embedded sensor instrumentality 604. Each member 612 of the audience has a bracelet that includes sensor instrumentality 606. Here, sensor instrumentality 604 detects, identifies and monitors the position of host 600 and ‘listens’ for his or her audio cues. Signals 608 are transmitted from sensor instrumentalities 606 to CPU 610. CPU 610 also receives signals 614 from and sends signals 616 to sensor instrumentality 604. In one use of this system, host 600 and audience members 612 are walking through rooms of a haunted house venue. When, for example, CPU 610 receives signals 608 that confirm that all of audience members are in a desirable position within the environment (e.g., an acceptable distance from moving doors and other equipment), CPU 610 can send within signal 618 an audio notification to an earpiece worn by host 600. Once host 600 is satisfied that audience members 612 are truly in the desired locations, if host 600 himself or herself are also in the location he or she is supposed to be, then when host 600 says the appropriate words, such words can be ‘heard’ by sensor instrumentality 604, which can then, through signals 614, sends to CPU 610, for example, a command to shut off the lights in the room and make internal lightening flash and thunder sound.

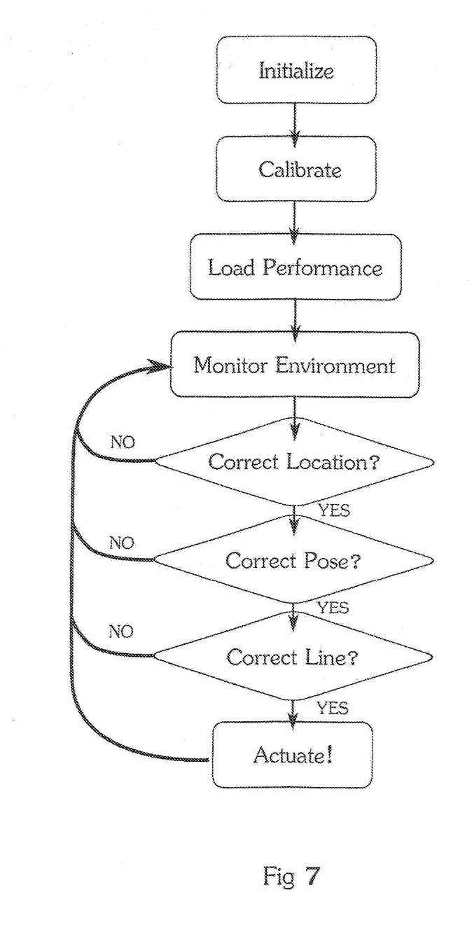

FIG. 7 shows a flow chart with the steps of an embodiment of the present inventive method. In some instances, the process starts with the establishment of the parameters that need to be met for there to be a change to be made in (A) one or more of the aspects of an environment (e.g., a change in the lighting in the environment or in an item in the environment), (B) one or more aspects of a garment of a person or animal in the environment, (C) aspects of a combination of the foregoing, or (D) some other element associated with the environment. Such parameters can include, for example, the specific location on a theatrical stage for the sensory instrumentality and the ‘hearing’ of a certain part of a script. The resulting parameters, when met, can cause the sensory instrumentality to transmit a signal that activates the motor that closes the curtain for the performance. Such a use can, for example, assist performers in confirming that they are in the correct position for the close.

In other instances, if the parameters have not been pre-established, then an additional step would include the setting of such parameters. One of ordinary skill in the art would realize that such parameters can be transmitted to the sensory instrumentality from a remote location or, if the sensory instrumentality includes the necessary functionality, such parameters can be set within the sensory instrumentality in real or near real time.

FIG. 7 also shows the step of the sensory instrumentality taking its initial readings (initializing). In this way, the sensory instrumentality establishes its initial position and assesses the conditions under which it is commencing its operations (e.g., the sensory instrumentality initializes with readings of the initial sounds, lighting, and signals in the area). Thereafter, the sensory instrumentality detects and monitors the environment, taking periodic readings of its position and other aspects of the environment.

The inventive method also includes the step of coordinating the relationship between the position(s) and other readings in anticipation of detecting a configuration that matches an actionable parameter. A separate step in the inventive method is the transmitting of a signal to a receiver when there is a match of the parameters. It is such receiver or the apparatus with which it is associated that causes the desired change in the environment or in an object therein.

A sensory instrumentality, with the capability of detecting and monitoring its position in the environment and other external aspects of it, monitors the environment, reading, for example, sounds in the environment, the movement of the sensory instrumentality or in its surroundings, lighting in the area, colors within its sensory range, surfaces with which it comes in contact, smells in proximity, tastes of objects placed against it, signals receivable by it, or combinations of the foregoing. In one embodiment of the present invention, the sensory instrumentality performs such monitoring when configured as an element of a wearable garment. In another embodiment, the sensory instrumentality performs such monitoring as, or as contained in, an object.

In the performance of the inventive method, the sensory instrumentality detects, identifies and monitors its position in the environment and receives the relevant aspect(s) of the environment (e.g., sounds, lighting, movement, colors, smells, tastes, signals etc.). Such sensory instrumentality either (x) interprets parameters and correlates its position(s) relative to the detected aspects and/or (y) electronically transmits the pertinent information (e.g., position and sensory readings) to a device that can analyze such information relative to such parameters. Based upon the correlation of parameters with the associated information, the present invention includes the step of transmitting a signal that can change (A) one or more of the aspects of the environment (e.g., it can cause a change in the lighting based upon the position of a costume wearer and sounds detected), (B) one or more aspects of a garment to which it is attached or object in which it is contained, (C) aspects of a combination of the foregoing, or (D) some other element associated with the environment.

One of ordinary skill in the art would recognize that the present invention can be used as a part of the function in other entertainment, sports, ‘everyday work’ or specialized environments, such as situationally-dependent safety equipment or periodic activity as part of a job or process. One benefit of the use of the present invention is the enablement of performances and other activities that are more flexible since the actions can be triggered in real time instead of being a cascade of timed events or a pre-set action.

Some of the examples of the use of the inventive system and/or method include, without limitation, guest interaction, stage performances, and parades. With guest interaction, e.g., in an environment with many guests (i.e., an audience), it is possible to operate the inventive system as part of an interactive experience. Take the King Arthur ‘sword in the stone’ exhibit example. Only the “right person” who uses the pre-established words would be able to, unbeknownst to the person, deactivate that magnets holding the sword in the stone. The host can issue costumes with an audio sensory instrumentality embedded to the guests and the sword will only interact when the person wearing such a costume says the pre-established words while pulling on the sword. A variant can be that every costume reacts to some activities, but not all (e.g., the “Jedi Training Academy” at Disney World uses costumes for every volunteer and these can be interactive costumes instead of basic fabric). For stage performances, the inventive system can be used for lighting, costuming, and visual effects on a stage. In connection with parades, a float, a prop, or the costume of the performer can react to the performer interacting with the float.

### ADDITIONAL THOUGHTS

The foregoing descriptions of the present invention have been provided for the purposes of illustration and description. It is not intended to be exhaustive or to limit the invention to the precise forms disclosed. Many modifications and variations will be apparent to the practitioner of ordinary skill in the art. Particularly, it would be evident that while the examples described herein illustrate how the inventive apparatus may look and how the inventive process may be performed. Further, other elements/steps may be used for and provide benefits to the present invention. The depictions of the present invention as shown in the exhibits are provided for purposes of illustration.

The embodiments were chosen and described in order to best explain the principles of the invention and its practical application, thereby enabling others of ordinary skill in the art to understand the invention for various embodiments and with various modifications that are suited to the particular use contemplated.

What is claimed is:

1. A system for interactively controlling aspects of an environment comprising:
a sensory instrumentality capable of detecting its position in the environment and detecting at least one audio cue within the environment;
means of comparing the position of the sensory instrumentality once the sensory instrumentality detects the audio cue with parameters that coordinate the position of the sensory instrumentality with the audio cue; and
means of generating at least one signal when there is a match of
the detected position of the sensory instrumentality,
the audio cue within the environment and
the parameters that coordinate the position of the sensory instrumentality with the audio cue, wherein a receiver of the generated signal causes a change in an aspect of the environment and wherein the sensory instrumentality transmits a signal that can change at least one aspect of a garment to which sensory instrumentality is attached.

2. The system of claim 1 wherein the external aspect of such environment is from the group of sounds therein, lighting therein, movements therein, colors therein, smells therein, tastes therein and electronic signals therein.

3. The system of claim 1 wherein such sensory instrumentality interprets parameters in correlating to such sensory instrumentality's position with relevant detected aspects.

4. The system of claim 1 wherein the sensory instrumentality electronically transmits its position and sensory readings to a means of analyzing information relative to the coordinating parameters.

5. The system of claim 3 wherein, based upon the correlation of such parameters with such sensory instrumentality's position with relevant detected aspects, such sensory instrumentality transmits a signal that can change at least one aspect of a garment to which such sensory instrumentality is attached.

6. The system of claim 1 wherein the sensory instrumentality transmits a signal that can change at least one aspect of another object within the environment.

7. The system of claim 1 wherein the coordinating parameters are pre-established and embedded within the sensory instrumentality.

8. The system of claim 1 wherein the coordinating parameters are receivable from a remote source.

9. The system of claim 1 wherein the coordinating parameters are established by activating a function in which the sensory instrumentality captures and stores, within the sensory instrumentality, the coordinating parameters in at least near real time.

10. A system for interactively controlling aspects of an environment comprising:
a sensory instrumentality capable of detecting its position in such environment and at least one external aspect of such environment, wherein
(i) the external aspect of such environment is from the group of sounds therein, lighting therein, movements therein, colors therein, smells therein, tastes therein and electronic signals therein,
(ii) such sensory instrumentality interprets parameters in correlating to such sensory instrumentality's position with relevant detected aspects, and
(iii) such sensory instrumentality electronically transmits its position and sensory readings to a means of analyzing such information relative to such parameters;
means of comparing such detected position and such external aspects of such environment with other parameters, wherein such other parameters are pre-established and embedded within such sensory instrumentality; and
means of generating at least one signal when there is a match of the detected position, such external aspect of such environment and such other parameters, wherein a receiver of such signal causes a change in an aspect of such environment.

11. A method of interactively controlling aspects of an environment comprising the steps of:
establishing the parameters that need to be met for there to be a change to be made in the aspects of such environment;
detecting, identifying and monitoring the position of a sensory instrumentality within such environment;
detecting and monitoring, through such sensory instrumentality, at least one external aspect of the environment;
interpreting parameters and correlating such parameters with position of the sensory instrumentality and with relevant detected aspects; and
transmitting a signal that can change an element associated with the environment.

12. The method of claim 11 wherein the external aspect of such environment is from the group of sounds in the environment, the movement of the sensory instrumentality in its surroundings, lighting in the area, colors within its sensory range, surfaces with which the sensory instrumentality comes in contact, smells in proximity, tastes of objects placed against the sensory instrumentality, and signals from an external source.

13. The method of claim 11 wherein such sensory instrumentality performs such monitoring when configured as an element of a wearable garment

14. The method of claim 11 wherein such sensory instrumentality performs such monitoring contained an object.

15. The method of claim 11 wherein such parameters are pre-established and embedded within such sensory instrumentality.

16. The method of claim 11 wherein such parameters are transmitted to such sensory instrumentality over time.

17. The method of claim 11 wherein such parameters are established by causing such sensory instrumentality to register such parameters by activating a function in such sensory instrumentality that captures and stores, within the sensory instrumentality, such parameters in at least near real time.
